(19) United States
(12) Patent Application Publication
(10) Pub. No.: US 2011/0150318 A1
(43) Pub. Date: Jun. 23, 2011

(54) DATA PROCESSING SYSTEM, DATA PROCESSING METHOD, AND INSPECTION ASSIST SYSTEM

(76) Inventors: Tomohiro Funakoshi, Hitachinaka (JP); Chikako Abe, Hitachinaka (JP); Hitoshi Sugahara, Hitachiota (JP)

(21) Appl. No.: 13/059,208

(22) PCT Filed: Aug. 14, 2009
(86) PCT No.: PCT/JP2009/064350

§ 371 Date: Feb. 15, 2011

(30) Foreign Application Priority Data
Sep. 25, 2008 (JP) 2008-245574

(51) Int. Cl. G06K 9/00

(52) U.S. Cl. 382/149

(57) ABSTRACT

Provided is a tool that can easily analyze a number of defects detected by an inspection system under a plurality of inspection conditions. The data processing system includes a storage device configured to acquire from an inspection system coordinates of a plurality of defects obtained by inspecting an inspection object under a plurality of inspection conditions and store the coordinates while correlating the coordinates with the inspection conditions, an arithmetic unit configured to perform coordinate matching to detect the presence or absence of coordinates that are common to at least two inspection conditions of the plurality of inspection conditions, and a display device configured to display on a plurality of defect coordinate maps the defects obtained under the at least two inspection conditions.

### TECHNICAL FIELD

The present invention relates to defect check work for products or parts that are being manufactured. In particular, the invention relates to a data processing system for assisting in determining the conditions for an inspection system that detects foreign particles or pattern detects on the surface of an inspection object such as semiconductor wafers, photomasks, magnetic disks, or liquid crystal substrates, and for a review system that observes defects such as foreign particles, and in improving the analysis efficiency for checking the performance of such systems; a data processing method; and an inspection assist system using the same.

### BACKGROUND ART

In the semiconductor manufacturing process, foreign particles or pattern defects on the surface of a wafer can result in a defective product. Therefore, it is always necessary to monitor if there is any problem in the manufacturing system and the manufacturing environment by quantitatively inspecting foreign particles, pattern defects, and pattern failures. Further, it is also necessary to observe the shapes of pattern failures to check if the pattern failures may have serious influence on the product.

Conventionally, such check work has been performed by human check. Therefore, there have been problems that different observers may determine the position or the type of a defect in the observed object in different ways, or the levels of defects that should be observed are not constant. Nowadays, techniques of automatic defect review (ADR) and automatic defect classification (ADC), in which a system automatically determines the size, shape, type, and the like of a defect using the image processing technique, are being introduced to solve the aforementioned problems (see Patent Document 1 and Patent Document 2, for example).

As described above, as review systems have been automated and improved in efficiency with the exercise of various ingenuity, the number of review systems that are introduced into a manufacturing line has been increasing, gaining more importance. Thus, inspection work for pattern failures and stuck foreign particles (hereinafter collectively referred to as “defects”) is very important to improve the yield as described above.

Meanwhile, with a reduction in the size of semiconductor devices, inspection systems have been required to have the ability and performance capable of detecting finer defects, and in response thereto, inspection systems that are capable of detecting defects with high sensitivity have emerged. However, as the high-sensitivity inspection systems have made detection of fine defects possible, the number of defects that are detected has correspondingly increased to several thousands to several tens of thousands. Thus, in order to optimize the inspection sensitivity of such inspection systems, in particular, enormous time has been spent in attempting a number of inspection conditions and performing review work to check defects detected under the inspection conditions.

Thus, there has been proposed a system that performs efficient work in observing, i.e., reviewing an inspected part such as a pattern formed on a wafer using a SEM (Scanning Electron Microscopy) observation system while reducing the operator's burden (see Patent Document 3 and Patent Document 4, for example).

For comparison of a plurality of inspection conditions to optimize the inspection conditions, it is necessary to extract detected defects that are unique to each individual inspection condition, that is, defects that have been detected under a particular inspection condition, and defects that are common to a plurality of inspection conditions, and perform review work on each defect so as to check what type of defect is present under what inspection condition. For example, when a result of matching defects, which have been detected under a plurality of inspection conditions, is sampled using the technique described in Patent Document 3, it may be difficult to optimize the inspection conditions due to an insufficient number of unique defects or common defects.
[Patent Document 1] JP Patent Publication No. 2007-40910
[Patent Document 2] JP Patent Publication No. 2007-184565
[Patent Document 3] JP Patent Publication No. 2003-59984
[Patent Document 4] JP Patent Publication No. 2006-173589

### DISCLOSURE OF THE INVENTION

### Problems to be Solved by the Invention

As described above, in the inspection condition optimization work that involves matching coordinate data of defects detected by a defect inspection system under a plurality of inspection conditions, sampling the matching result, and checking what type of defect is present under each condition using a review system, there have been cases in which, if there is a big difference in the number of defects detected under each inspection condition and the matching result is sampled as it is, an inspection condition with a small number of defects may not provide a sufficient number of unique defects. That is, there has not been any efficient sampling means or method with which unique defects that have been detected under each inspection condition or defects that are common to each inspection condition are included at a constant rate. Thus, it has been impossible to determine the optimal condition for an inspection system through efficient review work. Further, it has also been difficult to feed back the detected defect information accurately and timely to a manufacturing line.

It is an object of the present invention to provide a tool that can easily analyze a number of defects detected under a plurality of inspection conditions by an inspection system.

### Means for Solving the Problems

In order to solve the aforementioned problems, according to one aspect of the present invention, there is provided a data processing system that includes a storage device configured to acquire from an inspection system coordinates of a plurality of defects obtained by inspecting an inspection object under a plurality of inspection conditions and store the coordinates while correlating them with the inspection conditions, an arithmetic unit configured to perform coordinate matching to detect the presence or absence of coordinates that are common to at least two inspection conditions of the plurality of inspection conditions, and a display device configured to display on a plurality of defect wafer maps the defects obtained under the at least two inspection conditions.

The display device includes a selection screen for selecting a condition for sampling the defects by selecting the defect wafer map, and the arithmetic unit selects the defects in accordance with the sampling condition selected on the selection screen and displays the selected defects on the plurality of defect wafer maps displayed on the display device.

According to another aspect of the present invention, there is provided a data processing method that includes a step of acquiring from an inspection system coordinates of a plurality of defects obtained by inspecting an inspection object under a plurality of inspection conditions, a step of performing coordinate matching to detect the presence or absence of coordinates that are common to at least two inspection conditions of the plurality of inspection conditions, and a step of displaying on a plurality of defect wafer maps the defects obtained under the at least two inspection conditions.

The data processing method also includes a step of displaying a selection screen for selecting a condition for sampling the defects by selecting the defect wafer map, and a step of selecting the defects in accordance with the selected sampling condition and displaying the selected defects on the plurality of defect wafer maps.

According to still another aspect of the present invention, there is provided an inspection assist system that includes an inspection system configured to detect defects by inspecting an inspection object, a review system configured to re-detect the defects and classify the defects by type, a communication line that connects the inspection system and the review system, and a data processing system connected to the communication line and configured to acquire from the inspection system coordinates of a plurality of defects obtained by inspecting the inspection object under a plurality of inspection conditions, store the coordinates while correlating the coordinates with the inspection conditions, perform coordinate matching to detect the presence or absence of coordinates that are common to at least two inspection conditions of the plurality of inspection conditions, and display on a plurality of defect wafer maps the defects obtained under the at least two inspection conditions.

Further, in the inspection assist system, the data processing system includes a display device, the display device includes a selection screen for selecting a condition for sampling the defects by selecting the defect wafer map, and the data processing system selects the defects in accordance with the selected sampling condition so that the selected defects are displayed on the plurality of defect wafer maps displayed on the display device.

### Advantages of the Invention

According to the embodiment of the present invention, a tool that can easily analyze a number of defects detected under a plurality of inspection conditions by an inspection system can be provided.

### BRIEF DESCRIPTION OF THE DRAWINGS

FIG. 1 is a block diagram showing the configuration of an inspection system in the manufacturing process of a semiconductor device.

FIG. 2 is a block diagram showing a data processing flow of an inspection system.

FIG. 3 is an illustration diagram showing a screen displayed on a display device screen of a data processing system.

FIG. 4 is a flowchart showing the overall processing procedures of the present embodiment.

FIG. 5 is an illustration diagram showing a display screen that shows exemplary inspection maps.

FIG. 6 is an illustration diagram showing an exemplary Venn diagram display screen.

FIG. 7 is an illustration diagram showing an exemplary Venn diagram display screen.

FIG. 8 is an illustration diagram of a display screen that shows an exemplary Venn diagram area sampling window.

FIG. 9 is an illustration diagram of a display screen that shows an exemplary Venn diagram area sampling window.

FIG. 10 is an illustration diagram of a display screen that shows an exemplary Venn diagram area sampling window.

### BEST MODES FOR CARRYING OUT THE INVENTION

Hereinafter, an embodiment of the present invention will be described with reference to the drawings.

### [Basic Configuration]

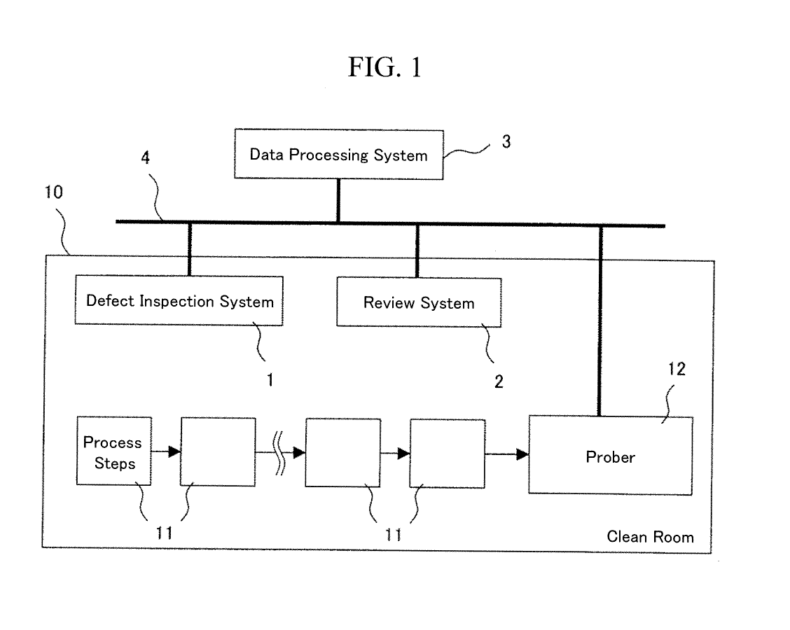

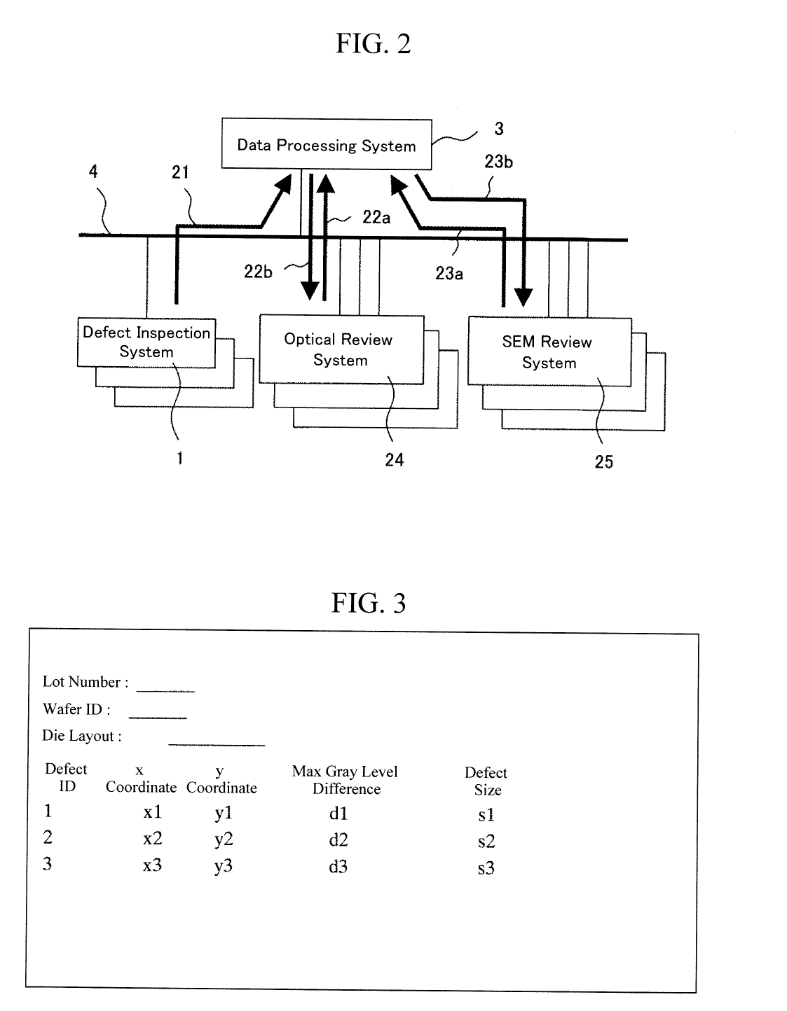

FIGS. 1, 2, and 3 show the overall configuration of the present invention. Shown herein is an example in which the present invention is applied to an LSI manufacturing line. FIG. 1 is a block diagram showing the configuration of an inspection system in the manufacturing process of a semiconductor device. FIG. 2 is a block diagram showing a data processing flow of a defect inspection system 1, a review system 2, and a data processing system 3. FIG. 3 is an illustration diagram showing a screen displayed on a display device screen of the data processing system.

In FIGS. 1 and 2, a plurality of semiconductor process step systems 11 is placed in a clean room 10 that typically maintains a clean atmosphere. A defect inspection system 1 that detects pattern failures on wafers of products, and a review system 2 that observes, i.e., reviews pattern failures on the basis of the data from the defect inspection system are provided in the clean room 10. The defect inspection system 1 and the review system 2 are connected to the data processing system 3 for transferring inspection data and image data via a communication line 4. Wafers to be processed into products are circulated through the semiconductor process step systems 11 on a lot basis. Reference number 12 denotes a prober. The review system 2 includes an optical review system 24 and an SEM review system 25 as described below with reference to FIG. 2.

For defect inspection, an inspection process is performed by transferring a wafer to the defect inspection system 1 by a worker or by robot transferring upon termination of a process step after which pattern inspection is determined to be performed in advance. The data processing system 3 includes an arithmetic unit such as a microprocessor (not shown), a storage device such as memory for storing received data, and a display device that displays the computation result of the arithmetic unit. The data processing system 3 sends and receives data to/from the defect inspection system 1 and the review system 2, holds the received data in the storage device, computes the data using a predetermined program, and displays the computation result on the screen of the display device.

Defect information 21 that is extracted in the defect inspection is managed by the data processing system 3 using a lot number, wafer number, inspection step, and inspection date and time. FIG. 3 is an illustration diagram showing an example of the defect information 21 displayed on the display device of the data processing system 3. This defect information 21 includes a lot number, wafer ID, die layout thereof, ID of a defect detected in the inspection, coordinate information thereof, and the like. Further, the defect information 21 also includes a defect ADR image, information on the defect feature amount, and the like, for example. This data is sent in a text data format that is determined with the other defect information. As a plurality of inspection conditions is attempted for optimization of the inspection conditions, the aforementioned data on the plurality of inspections is output from the inspection system.

Wafers that have undergone the defect inspection are transferred to the review system 2 so that pattern failures are observed. Then, a predetermined wafer is taken out of the lot for review. In the review, the defect information 21 is acquired from the data processing system 3 on the basis of the information on the wafer to be reviewed, i.e., a lot number, wafer number, and inspection step as key information. This information includes not only the defect ID and coordinate data but also an ADR image obtained during the inspection.

Referring to FIG. 2, as the amount of the defect information 21 output from the inspection system 1 is huge, defect information 22b and defect information 23b that are extracted by the data processing system 3 using a plurality of filter functions are sent to the optical review system 24 and the SEM review system 25, respectively via the communication line 4. The format of the defect information 22b and 23b is typically the same as that of the defect information 21.

The optical review system 24 or the SEM review system 25 acquires an image of the defect detected portion on the basis of the extracted defect information 22b or 23b, and classifies the defects by type using the image, with the use of the ADC function provided in each review system. Such information is fed back as ADR/ADC information 22a or 23a to the data processing system 3 via the communication line 4.

### [Display and Process of Inspection Data]

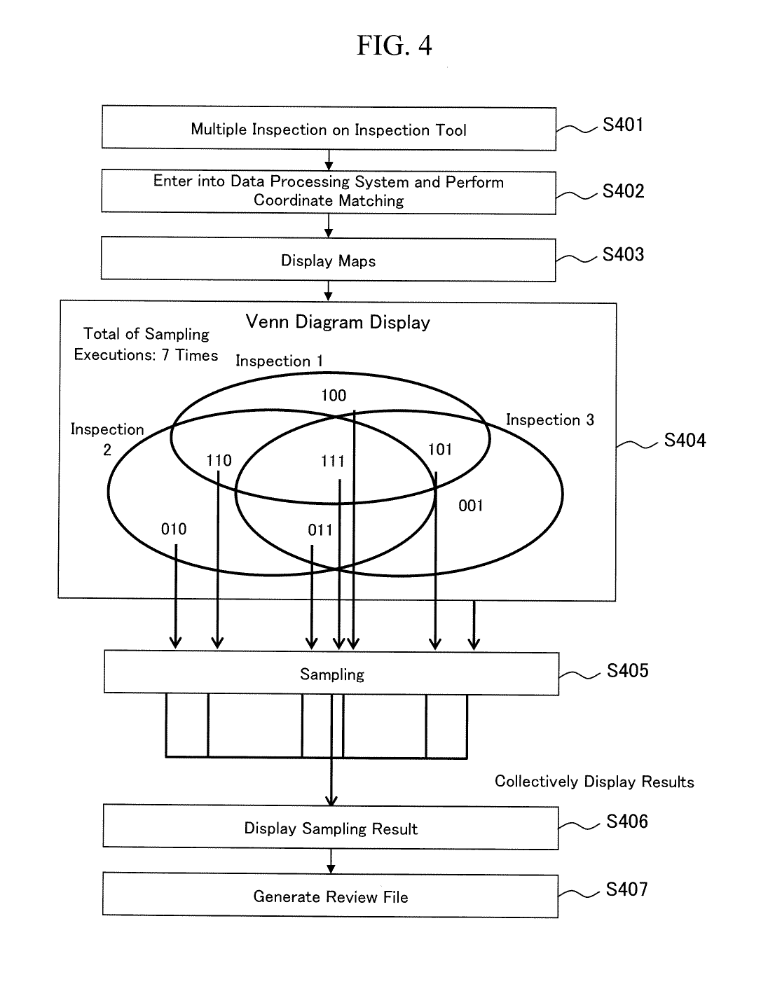

Described next is how to display and process a plurality of pieces of inspection data, which has been output from the inspection system, on the data processing system of the present invention. FIG. 4 is a flowchart showing the overall processing procedures of the present embodiment.

In order to determine the optimal condition for the inspection system, inspections are performed first under a plurality of inspection conditions such as the autofocus offset, light source wavelength, and polarization plate setting (step 401). Described below is a case in which three inspection conditions are selected as an example.

Coordinate data of defects extracted as a result of the inspections is sent as text data to the data processing system 3, which in turn performs coordinate matching of the defects detected under different inspection conditions and then determines if there is any defect that has been detected under more than one inspection condition (step 402).

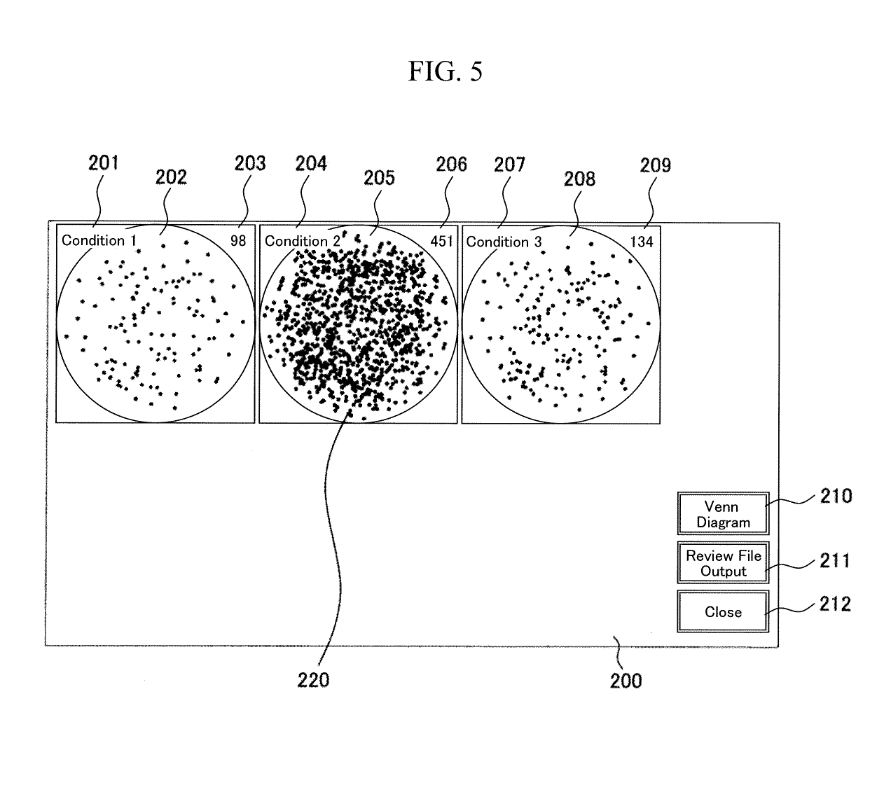

The data processing system 3 displays an inspection map for each of the three inspection conditions (step 403). FIG. 5 is an illustration diagram showing a display screen that shows exemplary inspection maps. Defect wafer maps 202, 205, and 208 for the three inspection conditions are displayed side-by-side on an inspection map display screen 200. Inspection condition names 201, 204, and 207 of the defect wafer maps 202, 205, and 208 are also displayed, and distribution of defects is displayed by dots 220 that indicate the positions of the detected defects on the basis of the defect coordinates. Each of number display portions 203, 206, and 209 displays the number of the detected defects included in each defect wafer map so that an operator can easily know the number of defects detected under each inspection condition.

On the screen shown in FIG. 5, if the operator selects a map that includes a defect, a review file of which is to be output, and presses a review file output button 211, a review file to be sent to the review system is output. If a close button 212 is pressed, the screen shown in FIG. 5 is closed.

If a Venn diagram display button 210 is pressed, defect coordinate data of the three inspection conditions is analyzed by matching so that defects that are unique to each individual inspection condition, or defects that are common to two or three inspection conditions are analyzed and displayed on a Venn diagram (step 404).

### [Venn Diagram Display]

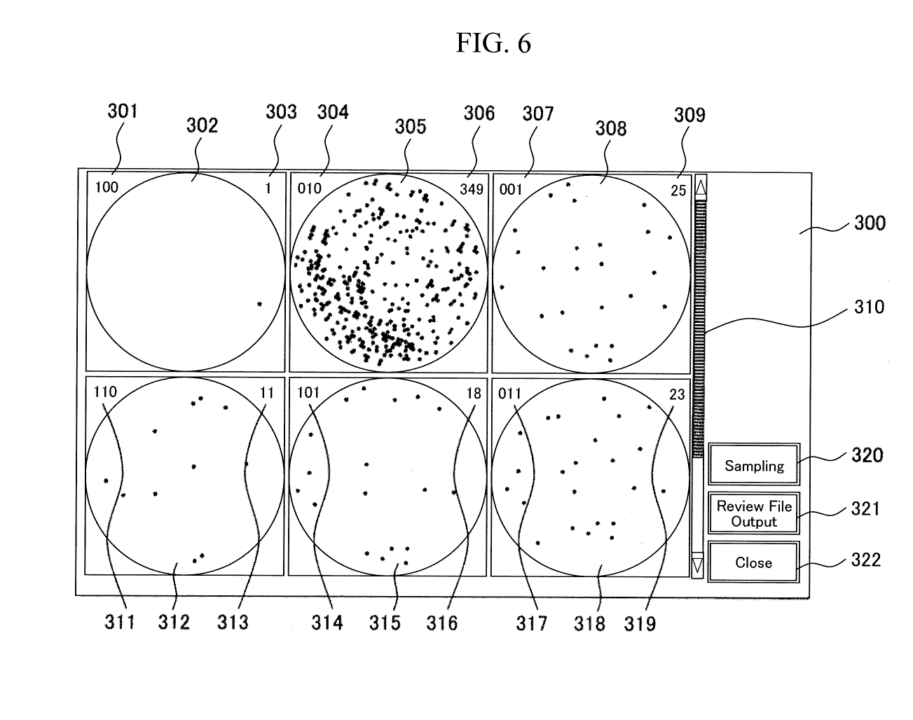

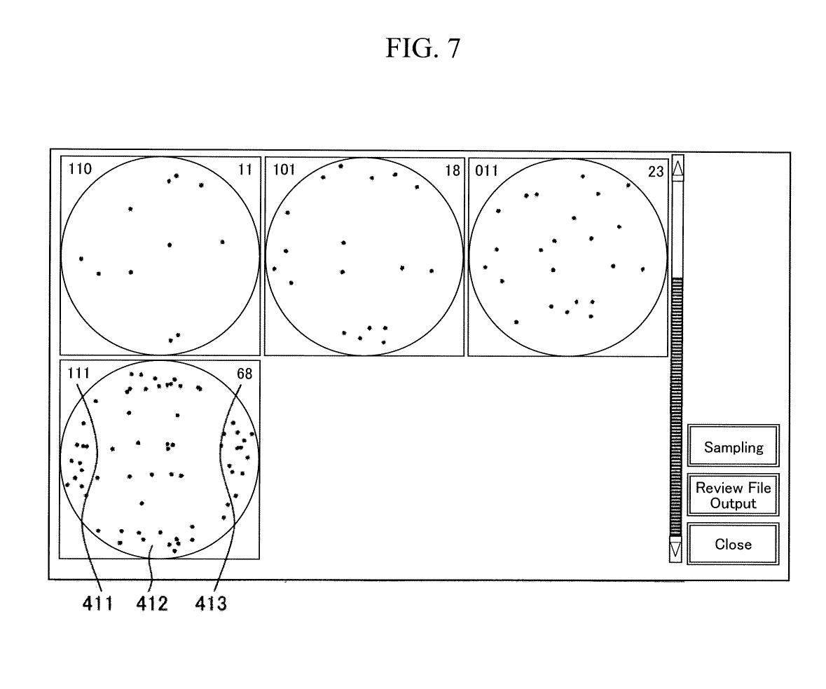

FIGS. 6, 7, and 10 are illustration diagrams each showing an exemplary Venn diagram display screen 300. FIG. 7 shows a result of sliding a scroll bar 310 in FIG. 6.

Map numbers 301, 304, 307, 311, 314, 317, and 411 are displayed on the upper left portions of Venn diagram maps 302, 305, 308, 312, 315, 318, and 412 so that it is possible to easily recognize under which inspection condition the defects shown on the defect wafer maps in FIGS. 6 and 7 have been detected. For example, referring to “100” of the map number 301, as the leftmost number that indicates an inspection condition 1 is “1,” the middle number that indicates an inspection condition 2 is “0,” and the rightmost number that indicates an inspection condition 3 is “0,” the map number 301 indicates a defect detected only under the inspection condition 1, i.e., a defect that is unique to the inspection condition 1. “110” of the map number 311 indicates defects that are common to the inspection conditions 1 and 2 and have not been detected under the inspection condition 3. “111” of the map number 411 in FIG. 7 indicates common defects that have been detected under all of the inspection conditions 1, 2, and 3. With this display method, it is possible to immediately understand which map belongs to which area of the Venn diagram of the plurality of inspection conditions. The aforementioned concept is shown in step 404 in FIG. 4. A single circle represents a single inspection condition, and the overlapped area represents defects detected under a plurality of inspection conditions.

Defect number display portions 303, 306, 309, 313, 316, 319, and 413 are provided on the upper right portions of the Venn diagram maps 302, 305, 308, 312, 315, 318, and 412 so that it is possible to determine which of the Venn diagram maps with similar defect distribution has more defects.

In the data processing system in accordance with the present embodiment, when any given defect wafer map on the Venn diagram display screen 300 shown in FIG. 6 is selected and a review file output button 321 is pressed, defect coordinate data included in the map can be sampled and output as a review file (step 405).

### [Sampling Display]

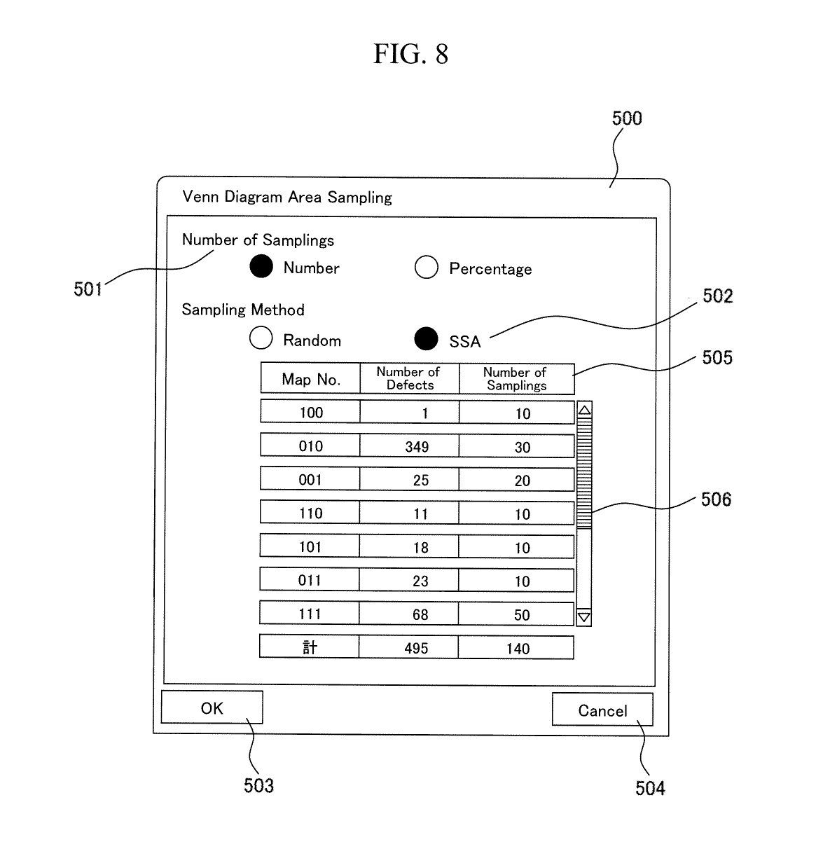

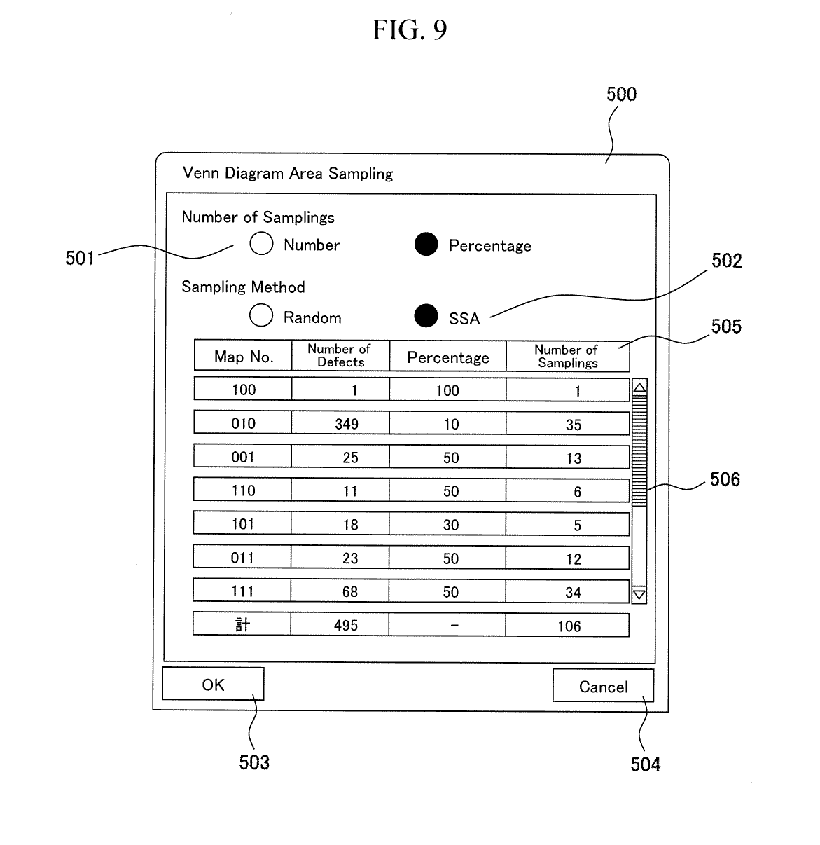

FIGS. 8 and 9 are illustration diagrams of a screen showing an exemplary Venn diagram area sampling window that is a selection screen for selecting sampling conditions. Further, a sampling button 320 for sampling the minimum required defects in each area of the Venn diagram is prepared so that defects that cover the entirety of each area of the Venn diagram is reviewed using a SSA (Spatial Signature Algorithm) that is a method for analyzing the spatial distribution of defect coordinates and sampling the minimum required defects to be reviewed as proposed in Patent Document 3 above, for example. When the sampling button 320 is pressed, a Venn diagram area sampling window 500 shown in FIG. 8 is displayed on the screen of the display device of the data processing system.

The Venn diagram area sampling window 500 includes buttons in an area 501 for selecting whether to specify the sampling by number or in percentage for each area of the Venn diagram, buttons in an area 502 for selecting whether to perform sampling randomly or with the aforementioned SSA method, an entry field 505 for specifying the number of defects and the number of samplings for each area of the Venn diagram, an OK button 503, a Cancel button 504, and a scroll bar 506.

If the percentage is specified in the area 501 for specifying the sampling, the entry field 505 changes as shown in FIG. 9, whereby it becomes possible to easily know the number of samplings specified corresponding to the percentage specified. The number of defect samplings may have fractions depending on the setting of the percentage. However, such fractions can be freely specified to be round off, rounded down, or rounded up.

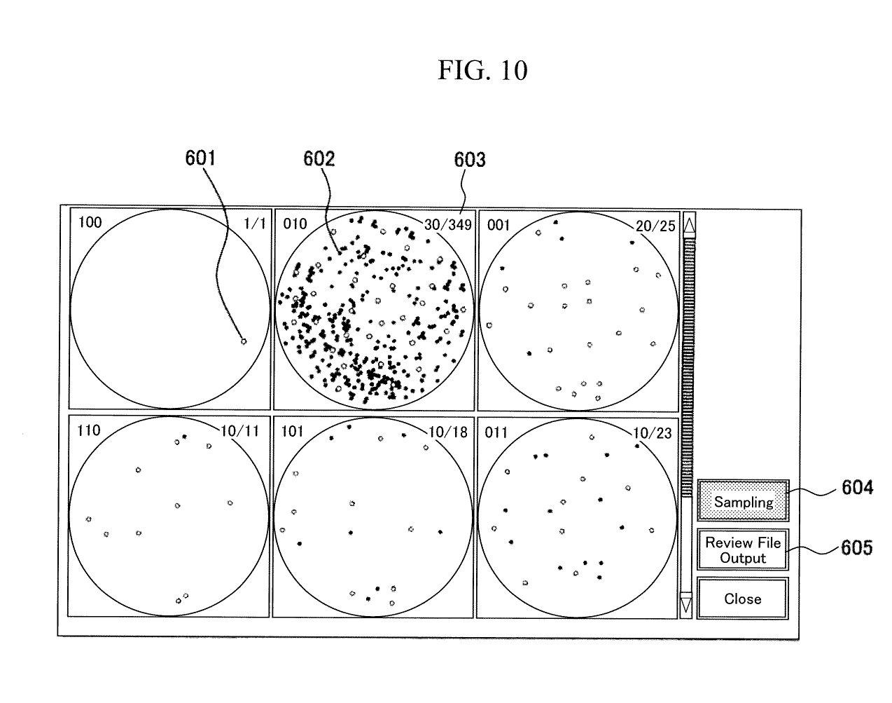

After any given number is entered as the number of samplings in FIG. 8 or the percentage in FIG. 9 and the OK button 503 is pressed, sampling is executed and the result is displayed in a window shown in FIG. 10 (step 406). The map shown in FIG. 10 can be recognized as being in the sampled state as the color of a sampling button 604 is inverted. When the sampling button 604 is pressed again, the sampled state is reset.

In each Venn diagram map of FIG. 10, sampled defects are displayed in hollow dots 601 and non-sampled defects are displayed in solid dots 602, for example. In addition, a sampled defect number display field 603 displays the number of the sampled defects and the total number of the defects on each Venn diagram map.

When a map to be output as a review file is clicked in the sampled state and a review file output button 605 is pressed, the map is output as text data and is output to the review system (step 407).

Although the present embodiment has illustrated an example in which three pieces of inspection data are matched, analyzed, and sampled, the scope of the present invention is not limited thereto, and it is also possible to similarly process two or four or more pieces of inspection data in the present invention.

According to the present invention, a plurality of inspection conditions is attempted with an inspection system. Then, in determination of which of the inspection conditions is the optimal inspection condition, defect coordinate data output from the inspection system is analyzed by matching. The result of the matching is displayed on Venn diagram maps, and each Venn diagram map is subjected to given sampling, whereby it becomes possible to comprehensively review and understand the defect types of defects detected under each inspection condition through the minimum required review work. Accordingly, it is possible to not only achieve an inspection under a more accurate inspection condition in a short time but also reduce the time for feeding back the defect inspection information to a manufacturing line, and improve the yield of the manufacturing line in a short time.

According to the present invention, in optimization of the inspection conditions for an inspection system through comparison between a plurality of inspection conditions, even if each inspection result includes a different number of detected defects, review data that is sent to the review system is configured to include defects such that the number of defects detected under each inspection condition is included at a constant rate. Thus, it is possible to accurately evaluate the defect types of defects detected under each inspection condition, realize optimization of the inspection conditions in a short time, reduce the time for feeding back the defect inspection information to the manufacturing line, and improve the yield of the manufacturing line in a short time.

### DESCRIPTION OF SYMBOLS

1 defect inspection system
2 review system
3 data processing system
4 communication line
200 inspection map display screen
202 defect wafer map
205 defect wafer map
208 defect wafer map
300 Venn diagram display screen
302 Venn diagram map
305 Venn diagram map
308 Venn diagram map
312 Venn diagram map
315 Venn diagram map
318 Venn diagram map
412 Venn diagram map
500 Venn diagram area sampling window
604 sampling button

1. A data processing system comprising:
a storage device configured to acquire from an inspection system coordinates of a plurality of defects obtained by inspecting an inspection object under a plurality of inspection conditions, and store the coordinates while correlating the coordinates with the inspection conditions;
an arithmetic unit configured to perform coordinate matching to detect the presence or absence of coordinates that are common to at least two inspection conditions of the plurality of inspection conditions; and
a display device configured to display on a plurality of defect wafer maps the defects obtained under the at least two inspection conditions.

2. The data processing system according to claim 1, wherein the display device includes a selection screen for selecting a condition for sampling the defects by selecting the defect wafer map, and the arithmetic unit selects the defects in accordance with the sampling condition selected on the selection screen, so that the selected defects are displayed on the plurality of defect wafer maps displayed on the display device.

3. A data processing method comprising:
a step of acquiring from an inspection system coordinates of a plurality of defects obtained by inspecting an inspection object under a plurality of inspection conditions;
a step of performing coordinate matching to detect the presence or absence of coordinates that are common to at least two inspection conditions of the plurality of inspection conditions; and
a step of displaying on a plurality of defect wafer maps the defects obtained under the at least two inspection conditions.

4. The data processing method according to claim 3, further comprising:
a step of displaying a selection screen for selecting a condition for sampling the defects by selecting the defect wafer map; and
a step of selecting the defects in accordance with the selected sampling condition, and displaying the selected defects on the plurality of defect wafer maps.

5. An inspection assist system comprising:
an inspection system configured to detect defects by inspecting an inspection object;
a review system configured to re-detect the defects and classify the defects by type;
a communication line that connects the inspection system and the review system; and
a data processing system connected to the communication line and configured to acquire from the inspection system coordinates of a plurality of defects obtained by inspecting the inspection object under a plurality of inspection conditions, store the coordinates while correlating the coordinates with the inspection conditions, perform coordinate matching to detect the presence or absence of coordinates that are common to at least two inspection conditions of the plurality of inspection conditions, and display on a plurality of defect wafer maps the defects obtained under the at least two inspection conditions.

6. The inspection assist system according to claim 5, wherein
the data processing system includes a display device,
the display device includes a selection screen for selecting a condition for sampling the defects by selecting the defect wafer map, and
the data processing system selects the defects in accordance with the selected sampling condition and displays the selected defects on the plurality of defect wafer maps displayed on the display device.
